(19) United States
(12) Patent Application Publication
(10) Pub. No.: US 2013/0034237 A1
(43) Pub. Date: Feb. 7, 2013

(54) MULTIPLE MICROPHONE SUPPORT FOR EARBUD HEADSETS

(71) Applicants: Sverrir Olafsson, Newport Beach, CA (US); Jonathan Chien, Tustin, CA (US); Lorenzo Crespi, Costa Mesa, CA (US); Trausti Thormundsson, Irvine, CA (US); James Bunde Villadsen Skov, Laguna Niguel, CA (US); Andrew B. Webster, Irvine, CA (US); Eitan David, Irvine, CA (US)

(72) Inventors: Sverrir Olafsson, Newport Beach, CA (US); Jonathan Chien, Tustin, CA (US); Lorenzo Crespi, Costa Mesa, CA (US); Trausti Thormundsson, Irvine, CA (US); James Bunde Villadsen Skov, Laguna Niguel, CA (US); Andrew B. Webster, Irvine, CA (US); Eitan David, Irvine, CA (US)

(21) Appl. No.: 13/560,290

(22) Filed: Jul. 27, 2012

Related U.S. Application Data
(60) Provisional application No. 61/515,206, filed on Aug. 4, 2011.

(51) Int. Cl. G10K 11/16; H04R 1/10

(52) U.S. Cl. 381/74

(57) ABSTRACT

A system for improved audio in a headset comprising a first headset microphone generating a first signal. A second headset microphone generating a second signal. A multiplexer coupled to the first headset microphone and the second headset microphone for multiplexing the first signal and the second signal. A power extractor for extracting power for use by one or more of the multiplexer, the first headset microphone and the second headset microphone. A demultiplexer for extracting the first signal and the second signal. A signal processor for generating a noise reduced microphone signal. An audio subsystem for receiving the noise reduced microphone signal and for generating speaker signals for a first headphone speaker and a second headphone speaker.

### RELATED APPLICATIONS

The present application claims priority to U.S. Provisional application No. 61/515,206, filed Aug. 4, 2011, which is hereby incorporated by reference for all purposes.

### TECHNICAL FIELD

The present invention relates to headphones, and more specifically to a multiple microphone system for an earbud headset.

### BACKGROUND OF THE INVENTION

Earbud headsets often come with a microphone built into a small enclosure attached to the speaker wiring. Voice signals recorded by these microphones typically have a low signal to noise ratio (SNR) because of the distance from the speaker's mouth and susceptibility to environmental noise.

### SUMMARY OF THE INVENTION

One way to improve the SNR is through multiple microphones. This disclosure presents a method to accomplish that while retaining compatibility with legacy earbud headsets.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE SEVERAL VIEWS OF THE DRAWINGS

Aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views, and in which:

FIG. 1 is a diagram of a system for improving the signal to noise ratio of a headset by using dual microphones in accordance with an exemplary embodiment of the present disclosure;

FIG. 2 is a diagram of a system for a simple multiplexer for a dual microphone headset using an oscillator in accordance with an exemplary embodiment of the present disclosure;

FIG. 3 is a diagram of a system for demultiplexer dual microphone headset signals by using carrier tracking in accordance with an exemplary embodiment of the present disclosure;

FIG. 4 is a diagram of a system for a multiplexer using pilot extraction for a modulation frequency in a dual microphone headset in accordance with an exemplary embodiment of the present disclosure;

FIG. 5 is a diagram of a system for a demodulator that uses an oscillator for demodulation and pilot insertion in accordance with an exemplary embodiment of the present disclosure; and

FIG. 6 is a diagram of a system for a signal processing algorithm based on spectral analysis and a spectral subtraction algorithm to generate a noise reduction filter in accordance with an exemplary embodiment of the present disclosure.

### DETAILED DESCRIPTION OF THE INVENTION

In the description that follows, like parts are marked throughout the specification and drawings with the same reference numerals. The drawing figures might not be to scale and certain components can be shown in generalized or schematic form and identified by commercial designations in the interest of clarity and conciseness.

Adding a second microphone to a headset assembly, preferably positioned so that the speech level is lower than in the primary microphone but such that it picks up the environmental noise, can be used to improve the signal to noise ratio of a headset microphone. The primary microphone can be placed on the side of the microphone enclosure closer to the user's mouth and the environmental noise microphone can point away from the speaker's mouth, or other suitable embodiments can be used. These microphones would typically be directional microphones, but could also be omnidirectional. Auto detection can be used to detect which of the microphones is oriented towards the user's mouth and which is oriented to pick up ambient sound.

In order to transport the second microphone signal to the codec of the playback/record device (e.g. an iPod), it can be frequency multiplexed with the primary microphone signal, for example by amplitude modulating it with a carrier signal using a dedicated IC. Other suitable modulation processes can also or alternatively be used, such as frequency modulation, time multiplexing methods, OFDM or others. The codec, which can be one that is specifically designed for this purpose, can then demodulate the signal back and with the appropriate signal processing combine the two microphone signals to produce a single input to the audio input sub-system. For other earbud headsets, the codec may detect that no second microphone signal is present and simply feed the single microphone signal through preserving compatibility with such headsets.

The circuitry in the enclosure to perform the multiplexing can draw current from the microphone bias supply or potentially through other means, such as rectifying a higher frequency AC power signal.

Once the two microphone signals have been sampled and brought into the playback/record device, noise reduction algorithms that take advantage of environmental noise reference signals can be used in addition to single-microphone algorithms.

This method can be extended to more than two microphones.

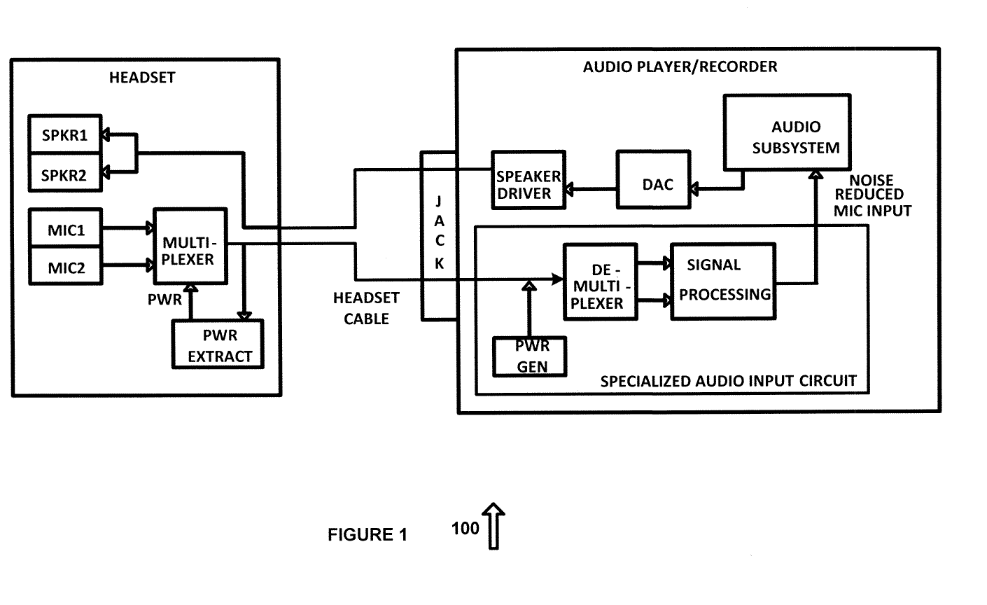

FIG. 1 is a diagram of a system 100 for improving the signal to noise ratio of a headset by using dual microphones in accordance with an exemplary embodiment of the present disclosure. System 100 can be implemented in hardware or a suitable combination of hardware and software, and can be one or more software systems operating on a digital signal processing platform. As used herein, “hardware” can include a combination of discrete components, an integrated circuit, an application-specific integrated circuit, a field programmable gate array, or other suitable hardware. As used herein, “software” can include one or more objects, agents, threads, lines of code, subroutines, separate software applications, two or more lines of code or other suitable software structures operating in two or more software applications or on two or more processors, or other suitable software structures. In one exemplary embodiment, software can include one or more lines of code or other suitable software structures operating in a general purpose software application, such as an operating system, and one or more lines of code or other suitable software structures operating in a specific purpose software application.

System 100 includes a headset having a plurality of speakers and a plurality of microphones. Two speakers and two microphones are shown for simplicity, but a suitable number of speakers and microphones can be used. A multiplexer is used to multiplex the microphone signals, which can receive power from the microphone input wire. Alternatively, if a wireless headset is utilized, the power can be extracted from the headset power source. The headset cable carries electrically or optically encoded audio signals, and interfaces with a jack on the audio player/recorder, which can be a stand-alone audio player and/or recorder, or the audio player and/or recorder function of a suitable device, including but not limited to a cell telephone, a laptop computer, a portable electronic device, a personal electronic device, a handheld computer, a notepad computer, or other suitable systems that can be used for telephonic communications.

The audio player/recorder includes a speaker driver, which can receive a speaker signal from the digital to analog converter (DAC) or other suitable devices. An audio subsystem or other suitable systems can drive the DAC. A power source in the device can provide a power signal to the headset cable, either as DC power or modulated as an AC power source. A demultiplexer demultiplexes the separate microphone signals from the headset, and a signal processing system or other suitable systems can provide the processed noise reduced microphone input to the audio subsystem.

In operation, system 100 allows dual microphone signals to be multiplexed onto a single circuit (wired, wireless or optical) for subsequent demultiplexing and processing to produce a noise reduced microphone signal.

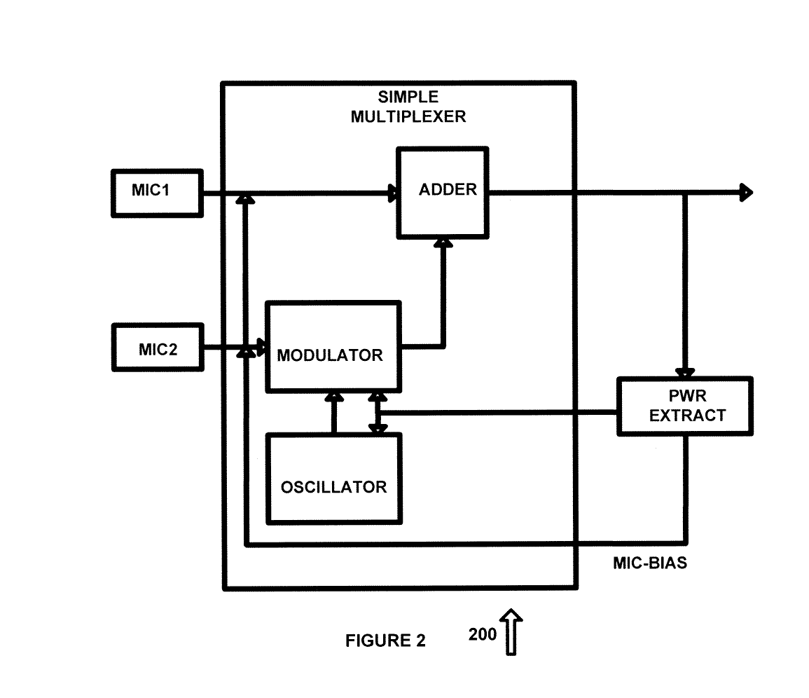

FIG. 2 is a diagram of a system 200 for a simple multiplexer for a dual microphone headset using an oscillator in accordance with an exemplary embodiment of the present disclosure. System 200 can be implemented in hardware or a suitable combination of hardware and software, and can be one or more software systems operating on a digital signal processing platform.

System 200 includes a first headset microphone, which is input into an adder, and a second headset microphone, which is modulated by a modulator to shift the center frequency of the audio signals recorded by the second headset microphone, and which is then input into the adder. An oscillator is used to control the modulation frequency of the modulator. A power extraction circuit extracts power from the microphone cable, and provides the power for components of system 200. Alternately, both microphone signals may be modulated to a higher frequency band, or combined in a different multiplexing scheme such as TDM, or through digital encoding, multiplexing followed by digital modulation.

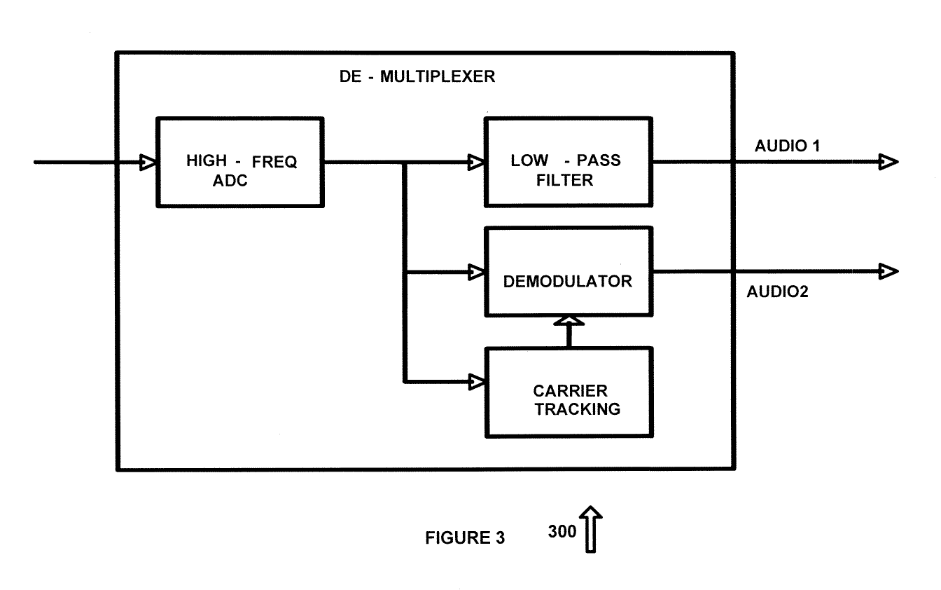

FIG. 3 is a diagram of a system 300 for demultiplexer dual microphone headset signals by using carrier tracking in accordance with an exemplary embodiment of the present disclosure. System 300 can be implemented in hardware or a suitable combination of hardware and software, and can be one or more software systems operating on a digital signal processing platform. System 300 includes a high frequency analog to digital converter, with a low pass filter to extract audio signal 1 and a demodulator to extract audio signal 2, such as where audio signal 1 has not been modulated and audio signal 2 has been modulated to shift the center frequency of the signal. Other suitable systems can be used to isolate audio signal 1 and audio signal 2. A carrier tracking system provides a reference signal input into the demodulator to be used for demodulation. Alternately, the low-pass filter, demodulator and carrier tracking can be implemented in the analog domain and the high frequency ADC replaced by a low frequency ADC for each microphone signal after demultiplexing.

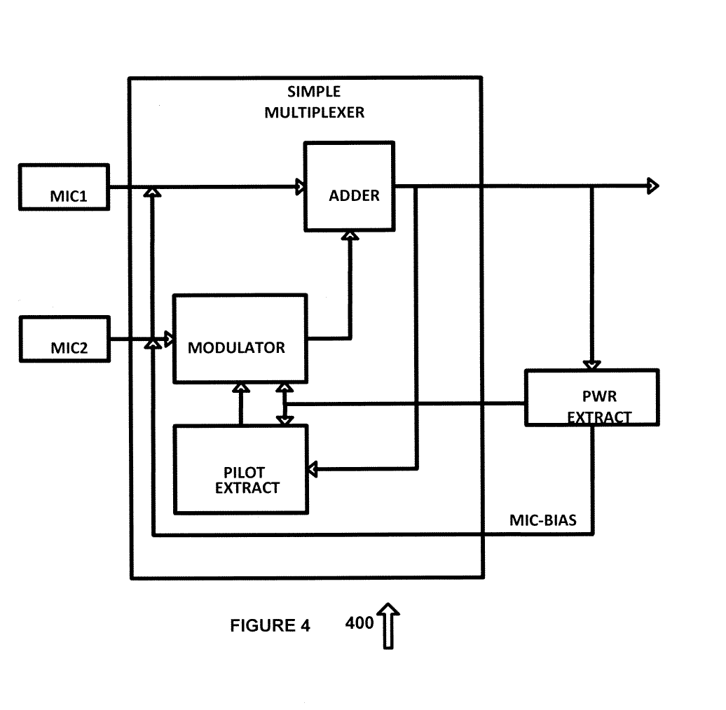

FIG. 4 is a diagram of a system 400 for a multiplexer using pilot extraction for a modulation frequency in a dual microphone headset in accordance with an exemplary embodiment of the present disclosure. System 400 can be implemented in hardware or a suitable combination of hardware and software. System 400 is similar to system 200 but uses a pilot extract to control the modulator. The same pilot may also be the AC power source for the headset circuitry.

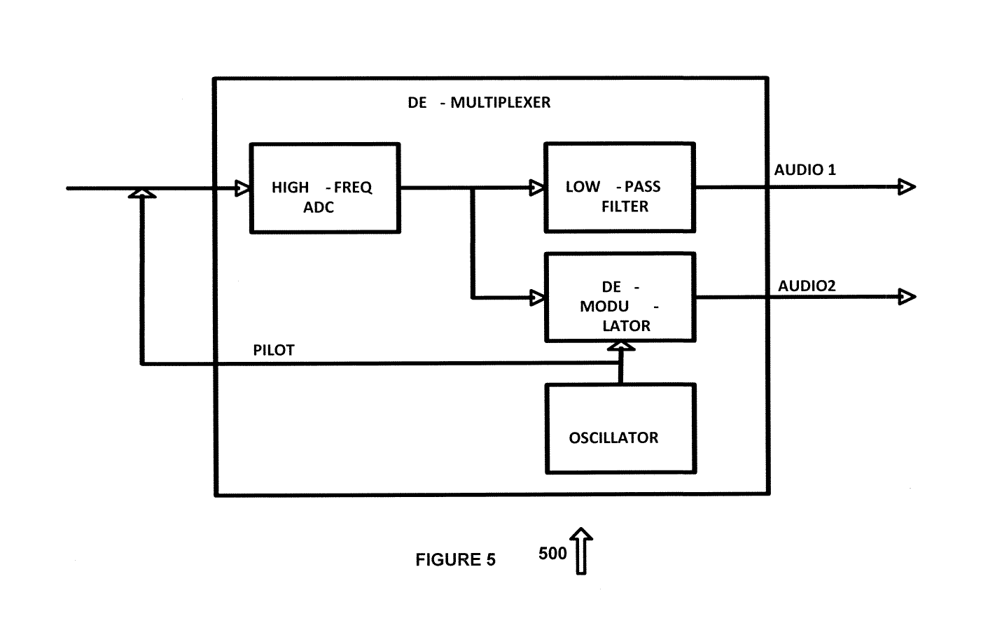

FIG. 5 is a diagram of a system 500 for a demodulator that uses an oscillator for demodulation and pilot insertion in accordance with an exemplary embodiment of the present disclosure. System 500 can be implemented in hardware or a suitable combination of hardware and software, and can be one or more software systems operating on a digital signal processing platform. System 500 is similar to system 300 but uses an oscillator to control the demodulator.

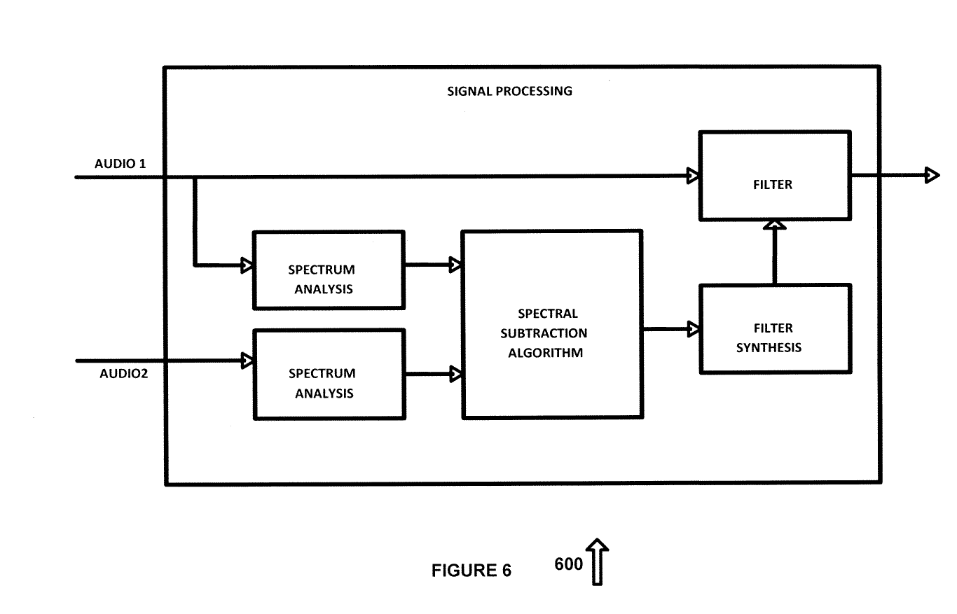

FIG. 6 is a diagram of a system 600 for a signal processing algorithm based on spectral analysis and a spectral subtraction algorithm to generate a noise reduction filter in accordance with an exemplary embodiment of the present disclosure. System 600 can be implemented in hardware or a suitable combination of hardware and software, and can be one or more software systems operating on a digital signal processing platform.

System 600 performs spectrum analysis of audio signal 1 and audio signal 2, and then performs spectral subtraction using a spectral subtraction algorithm to generate a spectral shaping control signal. The spectral shaping control signal is used by the filter synthesis to generate a filter that is applied to audio signal 1. In this manner, the signal to noise ratio of audio signal 1 can be improved. Other suitable algorithms exist that can be used to combine two microphone signals to improve SNR, such as a beamforming algorithm or the algorithm disclosed in U.S. application No.: 10/892,174 Publication number: U.S. 2006/0013412 A1. Filing date: Jul. 16, 2004, which is hereby incorporated by reference.

It should be emphasized that the above-described embodiments are merely examples of possible implementations. Many variations and modifications may be made to the above-described embodiments without departing from the principles of the present disclosure. All such modifications and variations are intended to be included herein within the scope of this disclosure and protected by the following claims.

What is claimed is:

1. A system for improved audio in a headset comprising:
a first headset microphone for generating a first signal;
a second headset microphone for generating a second signal;
power extraction circuitry coupled to a first end of a headset cable for extracting a power signal; and
a multiplexer coupled to the first headset microphone, the second headset microphone and the power extraction circuitry for multiplexing the first signal and the second signal.

2. The system of claim 1 further comprising a processor coupled to a second end of the headset cable for receiving the first signal and the second signal and generating a reduced-noise signal.

3. The system of claim 2 wherein the processor further comprises a demultiplexer for extracting the first signal and the second signal.

4. The system of claim 2 wherein the processor further comprises a signal processor for generating a noise reduced microphone signal.

5. The system of claim 4 wherein the processor further comprises an audio subsystem for receiving the noise reduced microphone signal and for generating speaker signals for a first headphone speaker and a second headphone speaker.

6. The system of claim 1 wherein the multiplexer comprises a modulator coupled to the headset microphone for modulating the second signal.

7. The system of claim 6 wherein the multiplexer further comprises an oscillator coupled to the modulator for to controlling a modulation frequency of the modulator.

8. The system of claim 6 wherein the multiplexer further comprises a pilot signal extractor coupled to the modulator for to controlling a modulation frequency of the modulator.

9. A method for improved audio in a headset comprising:
generating a first audio signal from a first headset microphone;
generating a second audio signal from a second headset microphone;
extracting a power signal from a first end of a headset cable; and
providing the power signal to a multiplexer for multiplexing the first audio signal and the second audio signal.

10. The method of claim 9 further comprising transmitting the multiplexed first and second audio signals to a processor at a second end of the headset cable.

11. The method of claim 10 further comprising:
demultiplexing the multiplexed first and second audio signals at the processor; and
performing a spectrum analysis of the first audio signal.

12. The method of claim 11 further comprising performing a spectrum analysis of the second audio signal.

13. The method of claim 12 further comprising performing spectral subtraction of the second audio signal from the first audio signal using a spectral subtraction algorithm to generate a spectral shaping control signal.

14. The method of claim 13 further comprising generating a filter using the spectral shaping control signal.

15. The method of claim 14 further comprising processing the first audio signal using the filter.

16. A system for improved audio in a headset comprising:
a first headset microphone for generating a first signal;
a second headset microphone for generating a second signal;
power extraction circuitry coupled to a first end of a headset cable for extracting a power signal;
a multiplexer coupled to the first headset microphone, the second headset microphone and the power extraction circuitry for multiplexing the first signal and the second signal;
a processor coupled to a second end of the headset cable for receiving the first signal and the second signal and generating a reduced-noise signal;
a demultiplexer for extracting the first signal and the second signal;
a signal processor for generating a noise reduced microphone signal;
an audio subsystem for receiving the noise reduced microphone signal and for generating speaker signals for a first headphone speaker and a second headphone speaker.

17. The system of claim 16 wherein the multiplexer comprises a modulator coupled to the headset microphone for modulating the second signal.

18. The system of claim 17 wherein the multiplexer further comprises an oscillator coupled to the modulator for to controlling a modulation frequency of the modulator.

19. The system of claim 17 wherein the multiplexer further comprises a pilot signal extractor coupled to the modulator for to controlling a modulation frequency of the modulator.
